(19) United States
(12) Patent Application Publication
(10) Pub. No.: US 2016/0299961 A1
(43) Pub. Date: Oct. 13, 2016

(54) System and method for grouping segments of data sequences into clusters

(71) Applicant: David Allen Olsen, Brooklyn Park, MN (US)

(72) Inventor: David Allen Olsen, Brooklyn Park, MN (US)

(21) Appl. No.: 14/998,896

(22) Filed: Feb. 28, 2016

Related U.S. Application Data
(63) Continuation-in-part of application No. 13/999,265, filed on Feb. 4, 2014.

(51) Int. Cl. G06F 17/30

(52) U.S. Cl. CPC G06F 17/30598; G06F 17/30259; G06F 17/30958

(57) ABSTRACT

A system and method for grouping segments of data sequences into clusters is a hierarchical clustering method that groups data points into clusters that are globular or compact. Cluster sets can be constructed only for each select level of a hierarchical sequence. Whether a level of a hierarchical sequence is meaningful is determinable prior the beginning of when the corresponding cluster set is constructible.

### RELATED APPLICATIONS

This application is a continuation-in-part of and claims the benefit of and right of priority to U.S. Nonprovisional patent application Ser. 13/999, 265, filed on Feb. 4, 2014, now pending, which claims the benefit of and right to priority to U.S. Provisional Patent App. No. 61/849,877, filed on Feb. 4, 2013, and U.S. Provisional Patent App. No. 61/852,603, filed on Mar. 16, 2013, all of which are hereby incorporated herein in their entirety by reference.

### COPYRIGHT NOTICE

A portion of the disclosure in this patent document contains material that is subject to copyright protection. The copyright owner has no objection if anyone makes a facsimile reproduction of the patent document or the patent disclosure, as it appears in the United States Patent and Trademark Office patent files or records, but otherwise reserves all copyright rights whatsoever.

### FIELD OF THE INVENTION

The present invention relates to a system and method for data processing. In particular, the present invention relates to a system and method for grouping segments of data sequences into clusters that are globular or compact and constructing one or more cluster sets of one or more hierarchical sequences.

### BACKGROUND

The demand for better product performance and product quality, greater product versatility, reduced error rates, and lower cost is driving a shift away from human operator control to “fly-by-wire” control. Isermann, Fault-Diagnosis Systems: An Introduction from Fault Detection to Fault Tolerance (2006). Judgment that was once exercised by human operators is being taken over by the computational components of cyber-physical systems. Moreover, since the behaviors of cyber-physical systems sometimes depend on sensed data and environmental conditions that cannot be fully replicated during the testing phase of product development, because testing is relative to the particular subsets of data that are provided as input, Buttazzo, Hard Real-Time Computing Systems (2005), greater reliance is being placed on more sophisticated supervisory control capabilities to maintain and ensure the safe operation of these systems. Thus, there is a corresponding demand for intelligence and data analysis capabilities that can provide this functionality. This is especially so with plant and equipment that, unlike many consumer products, is too costly to replace rather than repair.

Implementing a general clustering method in an autonomous system has eluded AI because the standard methods cannot be used without human intervention or considerable human supervision. For example, the complete linkage method (Sorenson 1948) (hereafter “standard CLM”) was the first among the standard hierarchical clustering methods to be developed during the late 1940's to the mid-1960's. Everitt et al., Cluster Analysis (2011). At that time, clustering problems having about 150 data points were viewed as moderately sized problems while problems having about 500 data points were viewed as large. Cf. Anderberg, Cluster Analysis for Applications (1973). To accommodate the hardware limitations of that time and solve these “large scale” clustering problems, those who developed standard CLM and the other standard hierarchical clustering methods assumed that cluster sets are nested partitions, i.e., that clusters are both indivisible and mutually exclusive. Jain and Dubes, Algorithms for Clustering Data (1988). Thus, the size of a fully constructed hierarchical sequence decreased from (n·(n−1))/2+1 levels to n levels, where n is the number of data points, Berkhin, A Survey of Clustering Data Mining Techniques (2006), and the number of combinations that needed to be examined at each level of a hierarchical sequence became much smaller than complete enumeration, Anderberg (1973). Moreover, except with respect to Ward's method, which uses an objective function, it was assumed that notions of distance between data points can be generalized to notions of distance between clusters of data points in order to devise proximity measures known as linkage metrics and combine or subdivide clusters (subsets) of data points at a time. Berkhin (2006). This work laid the foundation for the matrix updating algorithms. See, Jain (1988).

These assumptions sacrifice accuracy for efficiency when the inherent hierarchical structure in a data set is not taxonomic. See, e.g., Lance and Williams, Computer Programs for Hierarchical Polythetic Classification (“Similarity Analyses”) (1967), Olsen, The INCLude (InterNodal Complete Linkage) Hierarchical Clustering Method (2015), hereby incorporated herein in its entirety by reference. Moreover, other than when standard CLM is adapted for a particular purpose, it is still necessary to determine which levels of a constructed hierarchical sequence are meaningful. Typically, this is done by constructing a dendrogram, which is a visual representation of the hierarchical sequence. First, the results obtained from standard CLM are reviewed for inaccuracies. Then, the dendrogram is “cut” with a post hoc heuristic such as the gap statistic, Tibshirani et al., Estimating the Number of Clusters in a Dataset Via the Gap Statistic (2000), an heuristic for determining an “optimal” number of clusters k in a data set. All this is very time consuming and inconvenient. In industry, as much as 90 percent of the effort that goes into a standard CLM implementation is used to interpret results or develop stopping criteria (criteria used to bring an early halt to a hierarchical clustering process).

Despite these drawbacks, standard CLM continues to be an important hierarchical clustering method. The distributions of many real world measurements are bell-shaped, and standard CLM's simplicity makes it relatively easy to mathematically capture its properties while other methods show no clear advantage for many uses. See, e.g., U.S. Pat. No. 8,352,607 (load balancing), U.S. Pat. No. 8,312,395 (systematic defect identification), U.S. Pat. No. 8,265,955 (assessing clinical outcomes), and U.S. Pat. No. 7,769,561 (machine condition monitoring). Of the standard hierarchical clustering methods, standard CLM is the only method whose results are invariant to monotonic transformations of the distances between the data points, that can cluster any kind of attribute, that is not prone to inversions, and that produces globular or compact clusters. Johnson, Applied Multivariate Statistical Analysis (2002), Everitt (2011).

Nonetheless, the computational power now exists to apply hierarchical clustering methods to much larger data sets, and there are application domains such as many cyber-physical systems where accuracy and noise attenuation, i.e., reducing the effects of noise on cluster construction, are as important considerations as the size of the data sets. Cf, Bennett and Parrado-Hernandez, The Interplay of Optimization and Machine Learning Research (2006). Thus, assumptions that once were useful and perhaps even necessary to construct a hierarchical sequence of cluster sets may no longer be needed for some problems. Further, as the Internet of Things becomes reality and new services such as system maintainability by untrained users become important for many systems to have, see, e.g., Kopetz, Real-Time Systems: Design Principles for Distributed Embedded Applications (2011), academia and industry will find even more engineering applications for these methods. If the assumptions underlying standard CLM are unwound to improve the accuracy of complete linkage hierarchical clustering and bring it over from the “computational side of things . . . to the system [identification]/model [identification] kind of thinking”, Gill, CPS Overview (2011), numerous new problems will arise for which approaches need to be developed. Thus, both a recognized need and an opportunity exist to improve upon standard CLM.

### SUMMARY OF THE INVENTION

A system and method for grouping segments of data sequences into clusters regards a computer program encoded and a method implemented in a computational device, which computer program and method are used for constructing one or more cluster sets of one or more hierarchical sequences having one or more levels. The clusters of one or more embodiments are globular or compact, and one or more embodiments of the present invention are consonant with the model for a measured value that is commonly used by scientists and engineers: measured value=true value+bias (accuracy)+random error (statistical uncertainty or precision). Navidi, Statistics for Engineers and Scientists (2006). These embodiments use interpoint distances instead of intercluster distances to construct clusters and allow clusters to overlap and data points to migrate (as described below). To construct cluster sets for select levels of a hierarchical sequence instead of using information from one or more previously constructed cluster sets to construct subsequent cluster sets, cluster sets of a hierarchical sequence are constructed independently of one another, i.e., the cluster sets are constructed de novo. One or more embodiments decouple evaluating distances between data points for linkage information from cluster set construction.

One or more embodiments of the present invention are computer programs encoded in a computational device and include (without limitation) means for loading data into the computational device, wherein the data represent two or more data points, and wherein one or more indices are associated with each data point; means for calculating one or more sets of distances for the data points, wherein each set of distances includes one or more distances for each pair of data points, and indices of the respective data points are associated with the distances; means for evaluating a set of distances and the associated data points for linkage information; and means for using the linkage information to construct a cluster set only for each select level of the hierarchical sequence. In at least one embodiment, the cluster sets are constructed independently of one another.

One or more embodiments of the present invention include means for finding one or more meaningful levels of a hierarchical sequence that is constructible from a set of distances and the data points associated with these distances, wherein whether a level of the hierarchical sequence is meaningful is determinable prior to the beginning of when the corresponding cluster set is constructible. In at least one embodiment, one or more rank order indices are associated with each distance, and one or more differences between the distances and one or more differences between the rank order indices associated with these distances are used to find meaningful levels of a hierarchical sequence.

One or more embodiments of the present invention include one or more proximity vectors, where each proximity vector stores one or more sets of distances between the data points and indices of the respective data points, and where the distances and indices are evaluated for linkage information; one or more state matrices for storing linkage information derived from distances and indices stored in at least one of the proximity vectors; and one or more degrees lists for storing one or more degrees of the data points, where the degrees are derived from distances and indices stored in at least one of the proximity vectors. At least one state matrix and at least one degrees list are used to construct a cluster set only for each select level of a hierarchical sequence, where the cluster sets are constructed independently of one another.

One or more embodiments of the present invention are methods implemented in a computational device and include loading data into the computational device, wherein the data represent two or more data points, and wherein one or more indices are associated with each data point; calculating one or more sets of distances for the data points, wherein each set of distances includes one or more distances for each pair of data points, and indices of the respective data points are associated with the distances; evaluating a set of distances and the associated data points for linkage information; and using the linkage information to construct a cluster set only for each select level of the hierarchical sequence. At least one embodiment finds one or more meaningful levels of a hierarchical sequence that is constructible from a set of distances and the data points associated with these distances, wherein whether a level of the hierarchical sequence is meaningful is determinable prior to the beginning of when the corresponding cluster set is constructible. In at least one embodiment, the cluster sets are constructed independently of one another.

### FIGURES

FIG. 1 is a diagram of a hierarchical sequence.

FIG. 2 is a diagram of various data structures that are used in one or more embodiments of the present invention.

FIG. 3 is a diagram of a data structure that is used in one or more embodiments of the present invention.

FIG. 4 is an activity diagram of one or more processes that are used in one or more embodiments of the present invention.

FIG. 5 is a schematic of a distance graph being used to find meaningful levels of a hierarchical sequence.

FIG. 6 is a diagram of cluster patterns that are found in a cluster set.

FIG. 7 is pseudocode for one or more embodiments of the present invention.

FIG. 8 is pseudocode for one or more embodiments of the present invention.

FIG. 9 is pseudocode for one or more embodiments of the present invention.

FIG. 10 is pseudocode for one or more embodiments of the present invention.

FIG. 11 is pseudocode for one or more embodiments of the present invention.

FIG. 12 is pseudocode for one or more embodiments of the present invention.

### DETAILED DESCRIPTION

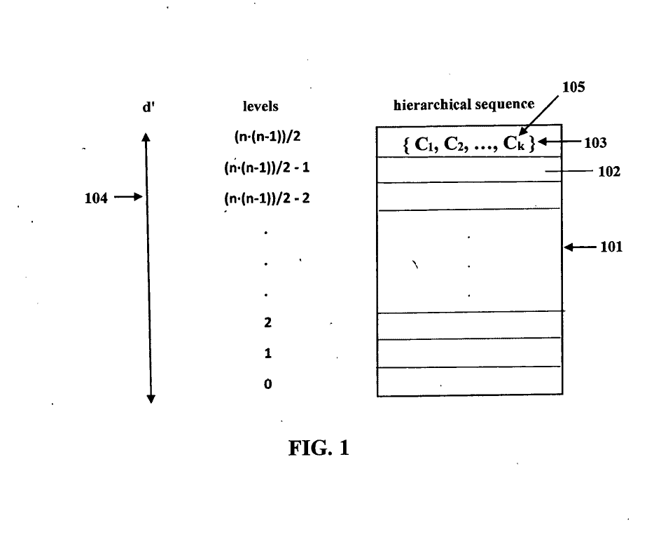

One or more embodiments of the present invention are used for constructing one or more cluster sets of one or more hierarchical sequences having one or more levels. As shown in FIG. 1, a hierarchical sequence 101 is a sequence of constructible cluster sets 103 that are arranged in an order that is determined by one or more indexing variables referred to as threshold indices 104, such as a threshold distance d′. The levels 102 of a hierarchical sequence 101 are the ordinal positions of the ordered sequence for which cluster sets 103 are constructible from a set of information whose state changes from one level 102 to the next, where the change in state is due to a change in at least one threshold index 104 (hereafter, the threshold distance d′ will be used as a running example). For example, let n be the number of data points in a data set and assume that a hierarchical sequence 101 is based on a particular distance measure between the data points. There will be (n·(n−1))/2+1 levels 102 in the hierarchical sequence 101, and the threshold distance d′ will have a value that corresponds to each level 102. A cluster set 103 is a set of clusters 105 that is constructible at a particular level 102 of the hierarchical sequence 101 and corresponding value of the distance threshold d′. Real world clusters are subsets of objects, events, or combinations thereof from a set of objects, events, or combinations thereof, which subsets are constructible according to some set of rules. Measurements and other numerical characterizations of these objects and/or events are used to mathematically represent two or more data points having one or more dimensions that describe the objects, events, or combinations thereof. Thus, in the abstract, clusters 105 are subsets of data points from a set of data points, which subsets are constructible according to some set of rules.

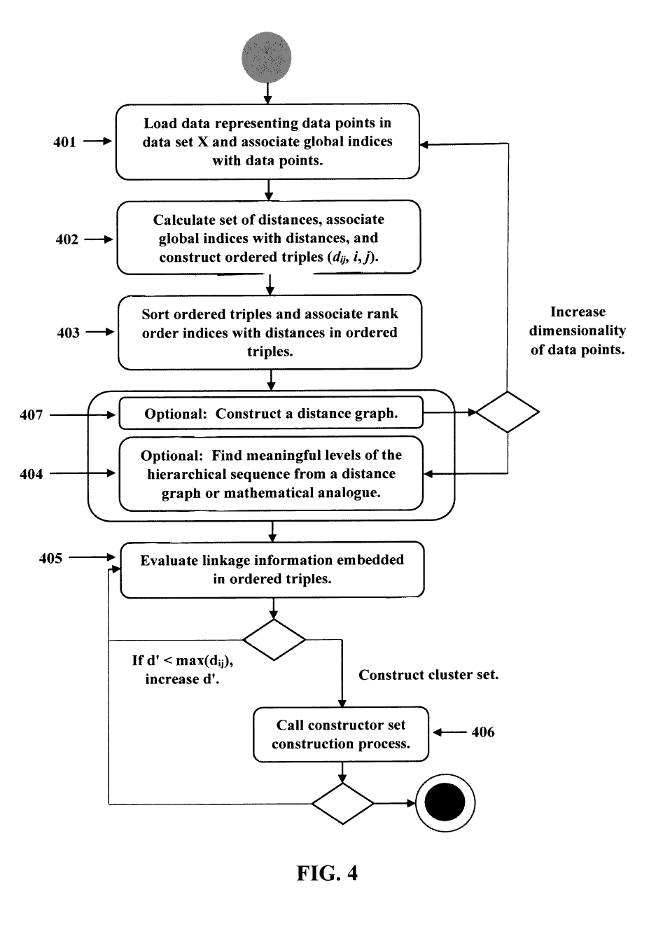

One or more embodiments of the present invention can be described as one or more of the following six processes illustrated in the activity diagram in FIG. 4: loading data 401 into the computational device, wherein the data represent two or more data points, and wherein one or more indices are associated with each data point; calculating one or more sets of distances 402 for the data points and associating indices of the respective data points with the distances; associating one or more rank order indices with each distance in a set of distances 403; finding one or more meaningful levels of a hierarchical sequence 404 that is constructible from a set of distances and the data points associated with these distances; evaluating a set of distances and the associated data points for linkage information 405; and constructing cluster sets (the cluster set construction process) 406. Unless the context indicates otherwise, the following description refers to agglomerative hierarchical clustering involving dissimilarity measures, although the concepts are equally applicable to divisive hierarchical clustering involving the same measures. For example, with respect to divisive hierarchical clustering, when a set of distances and the associated data points are evaluated for linkage information, they are evaluated in descending order, linkage information is removed from the state matrix, and the degrees of the data points are decremented. Similarity measures can be converted to dissimilarity measures or managed analogously in all six processes.

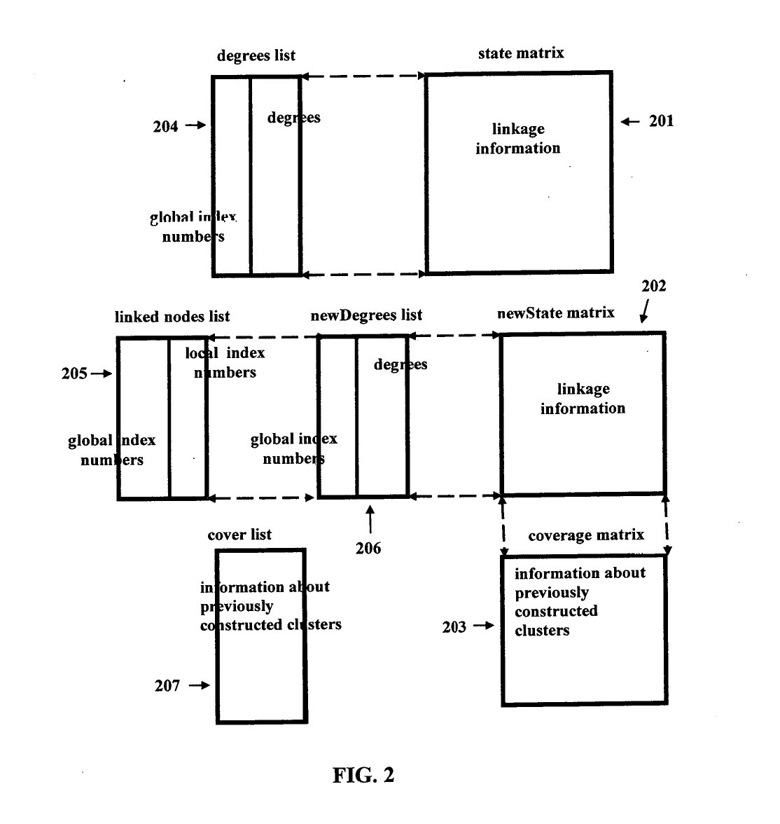

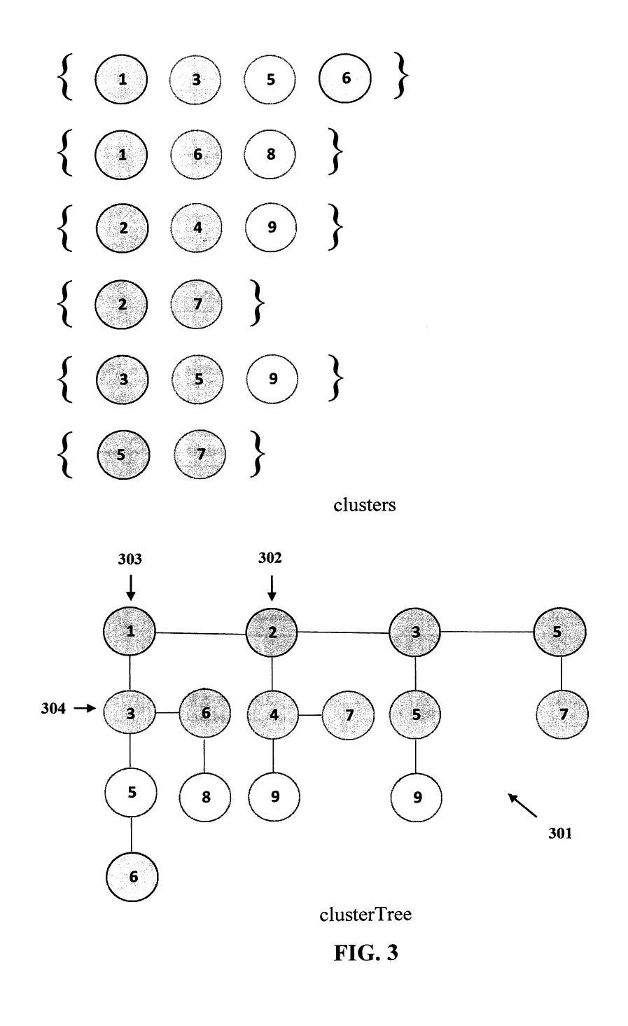

Let X={x₁, x₂, . . . , xₙ} be a data set that contains a finite number of data points n, where each data point has m dimensions. As further described herein, one or more of the following nine data structures may be used by various embodiments of the present invention, eight of which are used for cluster construction and are illustrated in FIGS. 2 and 3. The purpose and function of these data structures can be implemented in other forms as well.

A proximity vector is an (n·(n−1))/2×3 vector. Once the data points that comprise a data set are determined and at least the distances dᵢⱼ between the pairs of distinct data points xᵢ, and xⱼ, i,j=1, 2, . . . , n≠j are calculated, these distances and indices of the respective data points are used to construct ordered triples (d_{i,j},i,j), which are stored in a proximity vector.

A state matrix 201 is an n×n symmetric matrix, where n is the number of data points in the data set (or subset for clustering subproblems). A state matrix 201 is used to hold linkage information obtained from evaluating the ordered triples as of the threshold distances d′ (herein, unless the context indicates otherwise, the plural is used to refer to values of the threshold distance d′ while the singular is used to refer to the distance measure itself). This matrix is used by the cluster set construction process to construct cluster sets. The row and column indices of this matrix correspond to the indices of the data points.

A newState matrix 202 is a symmetric submatrix that is constructed from entries in a state matrix 201. When recursion is employed to solve a clustering subproblem, a newState matrix 202 is passed to a subroutine in the cluster set construction process, where the newState matrix 202 is used as a state matrix 201 to construct cluster subsets.

A coverage matrix 203 is a symmetric matrix that has the same size as a newState matrix 202 that has been passed to the recursive subroutine. Instances of a coverage matrix 203 hold information about previously constructed clusters (with respect to the cluster set being constructed). This information is used to construct newState matrices 202 and to avoid redundant cluster construction, i.e., recognizing the same cluster multiple times within the same cluster set. The indices of a coverage matrix 203 correspond to those of the newState matrix 202 with which it is associated.

A degrees list 204 is an n×2 list. An instance of a degrees list 204 holds one or more global indices of each data point and the degree of each data point as of the threshold distances d′. It is passed with the corresponding state matrix 201 to the cluster set construction process, where it is used to construct cluster sets. The row indices of a degrees list 204 correspond to the row and column indices of the corresponding state matrix 201.

A linked nodes list 205 is a 2-column list. Instances of a linked nodes list are used for cross-referencing between the global and local indices of an unmarked data point having the smallest degree and the indices of data points to which this data point is linked. Unless an unmarked data point having the smallest degree is a singleton, a linked nodes list 205 is created for each unmarked data point having the smallest degree.

A newDegrees list 206 is a 2-column list that has the same length as the corresponding instance of a linked nodes list 205. When recursion is employed to solve a clustering subproblem, a newDegrees list 206 is passed to the recursive subroutine in the cluster set construction process, where it is used as a degrees list 204 to construct cluster subsets. Unlike a newState matrix 202, however, a newDegrees list 206 is not a sublist of a degrees list 204. It is constructed de novo.

A cover list 207 is a list that is used to hold information about previously constructed clusters.

A clusterTree 301 is an adaptation of a binary search tree. Where the data points in each cluster of a cluster set are ordered, the right children 302 are data points that have the same position in each of the clusters of a cluster set, where position is determined from the left most data point. A parent 303 and a left child 304 come from the same cluster. A left child 304 is the data point that comes after the data point that is its parent 303.

Data set X is loadable 401 into the computational device in which the present invention is encoded in many different ways. For example, the data may be one or more streams of data that are loaded over a period of time, the data may be loaded in batches, or the data may be loaded by some combination thereof. The data may be real-time data, the data may have been previously stored, the data may have come from one or more locations, and/or the data may be all the same kind or a mixture of different kinds. The data are measurements and/or other numerical descriptions of objects and/or events that represent two or more data points. These data points may be segments from a sequence of data, such as samples taken over different time intervals from the same sensor, or segments of data from more than one sequence of data. They may be comprised of one kind of data or composites of different kinds of data, or some combination thereof. One or more identifiers or other indices are associated with each data point in order to identify the data point throughout the system and method. These identifiers or indices are also referred to as global indices.

One or more sets of distances are calculated 402 between at least each pair of distinct data points from the set of data points. For each set of distances, one or more distance measures are used to calculate the distances, wherein at least one distance measure is used to calculate each and every such distance. Two examples of distance measures are Euclidean distance and cityblock distance. Other examples are available in Johnson (2002), and still other examples are known to those skilled in the art. Calculating distances between pairs of data points can be broken into parts. For example, the dissimilarity between one or more dimensions of two data points can be calculated and a p-norm, p ∈[1,∞), can be used to find the length or magnitude of the resultant vector of values. Taking simple differences between the dimensions of pairs of data points and finding the 2-norm and the 1-norm of the resultant vectors produces Euclidean distances and cityblock distances, respectively. The distances d_{i,j} and the indices of the respective data points xᵢ and xⱼ are used to construct ordered triples (d_{i,j},i,j), which are stored in a proximity vector. Other means of organization and storage, such as a matrix, are known to those skilled in the art.

The rank order of the ordered triples is useful for making it easier to evaluate the ordered triples for linkage information and for determining whether or not a level of a hierarchical sequence is meaningful. Here, meaningful is used to describe significant relationships in the inherent structure of a data set, such as where new configurations of clusters have finished forming. Thus, one or more embodiments of the present invention sort or order the ordered triples according to their distance elements d_{i,j} 403. The row indices of the proximity vector in which the sorted ordered triples are stored are used as the rank order indices or “roi” of the ordered triples and their distance elements. Where they are useful, binning or search or other means can be used to achieve the granularity of order that is desirable.

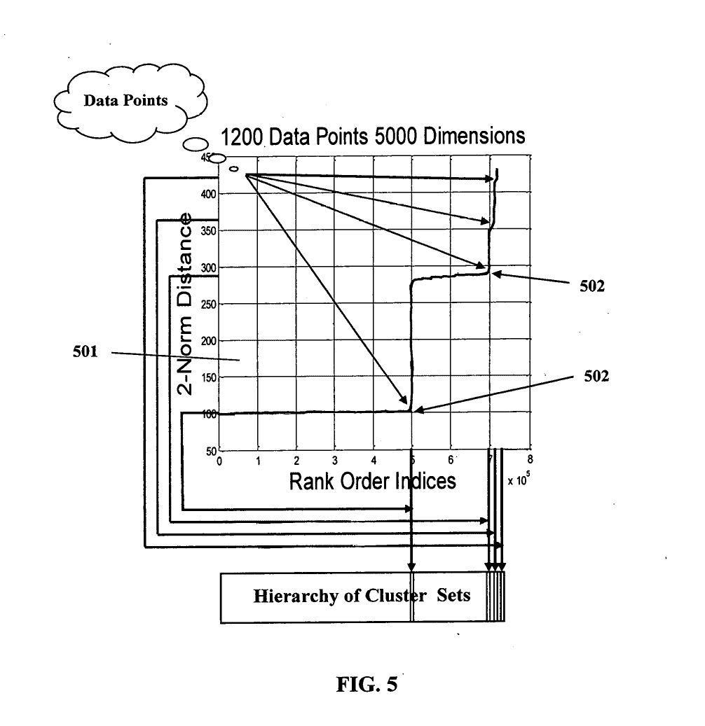

Finding meaningful levels of a hierarchical sequence 404 that is constructible from a set of distances and the data points associated with these distances, such as the ordered triples, can be achieved in different ways. This information can be used to construct one or more images 407 that can be visually examined for one or more features that correlate with meaningful levels of a hierarchical sequence. One example, shown in FIG. 5, is a distance graph 501, wherein rank order indices are the independent variable values and distance elements are the dependent variable values, and wherein the lower right corners 502 of the distance graph correspond to meaningful levels of the hierarchical sequence when these corners are well-defined. See, Olsen, Selecting Meaningful Levels of a Hierarchical Sequence Prior to Cluster Analysis (2014a), hereby incorporated herein in its entirety by reference. Another example is a bar graph, and still another example is a test that is performed prior to the beginning of when a cluster set is constructible. Determining whether a level of a hierarchical sequence is meaningful, and consequently whether the corresponding cluster set is meaningful, is used to decide whether or not the cluster set should be constructed.

Assuming that the ordered triples have been sorted, the ordered triples are evaluated in ascending order for linkage information 405 that is embedded in each ordered triple and all the previously evaluated ordered triples. This information is recorded in a state matrix while the degrees of the data points are concurrently tracked in a degrees list. The degree of a data point refers to the number of other data points to which the data point is linked, based on the threshold distance d′ for the hierarchical sequence.

Linkage information is information about the linkage between the data points in a data set, as determined by the threshold distance d′ for the hierarchical sequence. The threshold distance d′∈R is a continuous variable that determines which pairs of data points in a data set are linked and which are not. Data points xᵢ, and xⱼ, i,j=1, 2, . . . , n, i≠j, are linked if the distance between them is less than or equal to threshold distance d′, i.e., d_{i,j}≦d′. Other greater than/less than and inclusion/exclusion relationships based on other threshold indices are also possible for determining linkage among the data points. From the linkage information that is recorded in the state matrix and the degrees of the data points, a set of globular or compact clusters is constructible.

The cluster sets evolve as a function of threshold distance d′. To construct a (sub)set of clusters 406, one or more embodiments of the present invention find unmarked data points having the smallest degree and use these data points to initiate constructing at least one cluster. For example, if xᵢ is an unmarked data point having the smallest degree and its degree equals 1, data point xᵢ comprises a cluster with the data point to which it is linked. Unmarked data points having the smallest degree are used for constructing those clusters that are necessary and distinct while minimizing the use of recursion. Extra links, i.e., links between data points that do not belong to the same cluster, are ignored (pruned). If more than one data point qualifies as the data point having the smallest available degree, the data point having the smallest index is used first.

The state matrix is used to locate those data points to which unmarked data point xᵢ having the smallest degree is linked. This subset of data points (including xᵢ) is examined for maximal completeness. If the subset is maximally complete and at least one pair of these data points has not been included in a previously constructed cluster, the subset is recognized as a cluster, and each data point is marked so that it cannot be (re-)selected as a data point having the smallest degree. There are many different ways to indicate that data points no longer qualify for being selected as a data point having the smallest degree. One way of marking data points increases their degrees to n+1 and limits which data points qualify for being selected to those data points whose degrees are less than n.

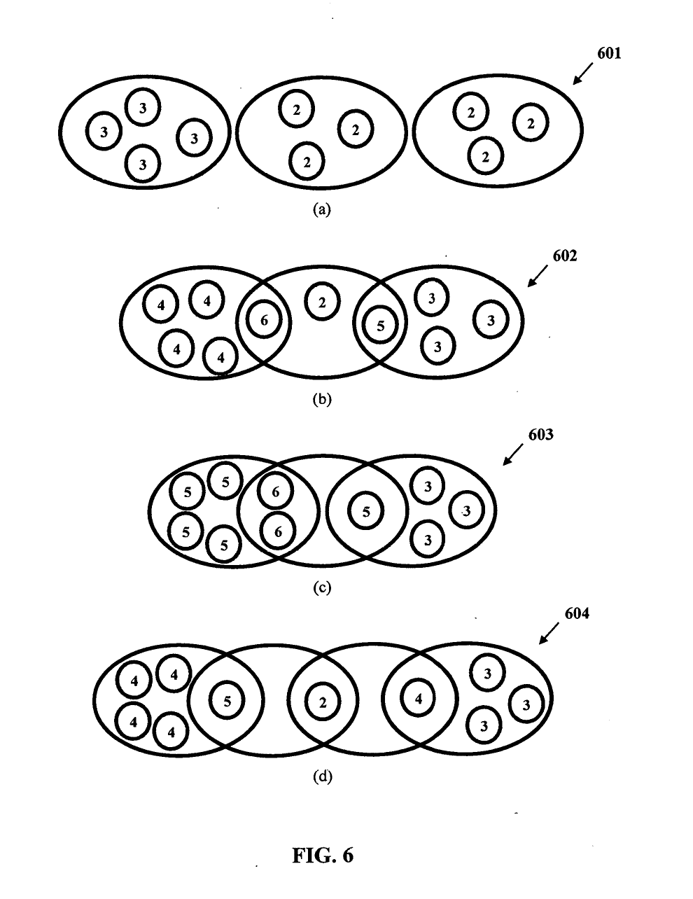

The relationship between clusters from the same cluster set can be described by one of the four cluster patterns illustrated in FIG. 6, or combinations thereof. In FIG. 6 (a) 601, the clusters are non-overlapping, and at least one data point in each cluster is well-separated. (This is in contrast to where all the data points are well-separated and therefore the cluster is well-separated.) In FIG. 6 (b) 602, the clusters overlap, but at least one data point in each cluster is well-separated. The degree of a data point that belongs to multiple overlapping clusters is greater than the degrees of those data points that belong to only one of the clusters. In FIG. 6 (c) 603, the subset of data points encircled by the dashed line also belong to clusters wherein at least one data point is well-separated. The data points of the subset migrate to these clusters, and a cluster comprised of the subset of data points is not constructed. These three patterns comprise ideal circumstances, because at least one data point in each constructed cluster is well-separated. In these circumstances, cluster sets can be constructed without resorting to recursion to solve clustering subproblems.

When a subset of data points is not maximally complete, nonetheless, it comprises a subset of overlapping, maximally complete clusters 604. The subset of clusters is treated as a clustering subproblem, and recursion is employed to identify the overlapping clusters. When inherent hierarchical structure in a data set is weak, recursion is employed often. In these circumstances, it may be preferable to limit the depth to which recursion is employed and list the data points that comprise the unresolved subproblems. One or more embodiments treat the list as a cluster, the shape of which is globular or compact, even though it is not maximally complete. On the other hand, when inherent hierarchical structure is well-defined, it is easy to identify meaningful levels of a hierarchical sequence and construct cluster sets only for these levels. Then, recursion is used less often, if at all. Where weak structure is a consequence of noise that is embedded in the measured values of the data points, under a broadly applicable set of conditions, increasing the dimensionality of (number of samples in) the data points can attenuate the effects of such noise on cluster construction. See, Olsen (2014a). When recursion is used, only those data points whose linkage is coextensive with that of data point xᵢ (including xᵢ) are marked.

After it is determined whether a maximally complete subset of data points should be recognized as a new cluster or the recursive subroutine returns, one or more embodiments find the next unmarked data point having the smallest degree. The cluster set construction process reiterates until all the data points are marked, at which time the process returns and the next ordered triple is evaluated for linkage information.

In summary, these embodiments use four criteria to construct cluster sets. First, cluster construction is based solely on interpoint distances instead of intercluster distances. Second, every cluster is globular or compact by construction, and preferably maximally complete. Third, clusters are allowed to overlap, and because cluster sets are constructed de novo, data points can migrate. Constructing cluster sets de novo is also useful for constructing only cluster sets that correspond to select levels of a hierarchical sequence, i.e., levels that are chosen or deliberately constructed as opposed to constructed out of necessity. Fourth, one or more embodiments seek to construct globular or compact clusters from subsets of data points, except those from which all the data points migrate. Alternative embodiments also include some or all of the subsets from which data points migrate. At least one embodiment does not recognize a cluster if each pair of data points in the maximally complete subset of data points has been included in a previously constructed cluster (with respect to the same cluster set). Other embodiments implement a clusterTree data structure. To determine whether such a maximally complete subset of data points is recognizable as a cluster, the clusterTree is checked. If the subset was previously included, it is ignored. Otherwise, it is recognized and added to the clusterTree.

One or more preferred embodiments can be described further as follows:

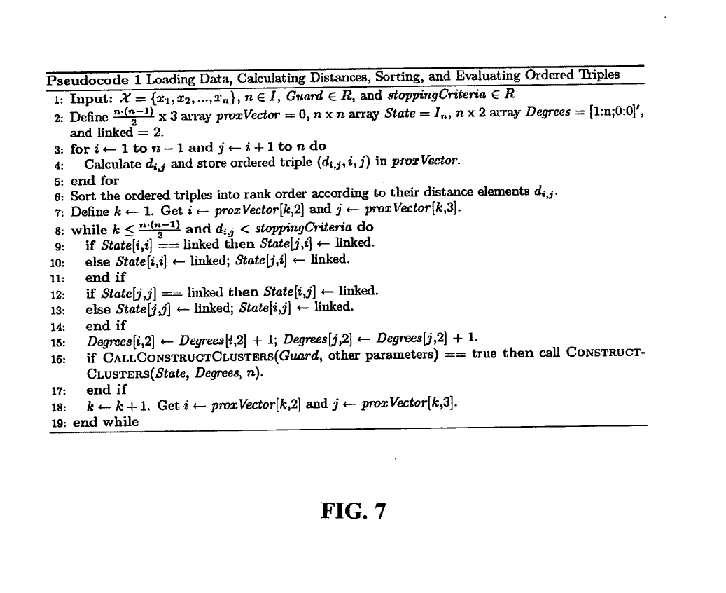

FIG. 7, Pseudocode 1 Line 1. One or more preferred embodiments take a finite set of data points X={x₁, x₂, . . . , xₙ}, the size n of data set X, a first optional control parameter Guard, and a second optional control parameter stoppingCriteria as input. The data points are stored as rows in a data array, the row indices of which are used as global indices to refer to the data points, n can be determined as or after X is input. Guard controls when or how often cluster sets are constructed, and stoppingCriteria controls the lowest resolution at which ordered triples are evaluated. In effect, it determines the lowest resolution at which a cluster set can be constructed. Examples of control parameters include the rank order indices, threshold indices such as threshold distances d′, and numbers of clusters. An example of a more sophisticated control parameter for Guard that looks for meaningful levels of a hierarchical sequence is the following test that uses p-norms, p ∈[1,∞) , to calculate the distances:

DISTROIᵢ₊₁−DISTROIᵢ≧tan(cutoffAngle)−MAXDIST/MAXROI,

where DISTROIᵢ is the distance element of the ith ordered triple, DISTROIᵢ₊₁ is the distance element of the i+1th ordered triple, cutoffAngle is the minimum angle that the distance graph must form with the x-axis of the graph in the positive direction at roi=i in order to construct a cluster set once the ith ordered triple is evaluated for linkage information, MAXDIST is the largest distance element of all the ordered triples, and MAXROI is the number of ordered triples. See, Olsen, An Approach for Closing the Loop on a Complete Linkage Hierarchical Clustering Method (2014b), hereby incorporated herein in its entirety by reference.

FIG. 7, Pseudocode 1 Line 2. An instance of proxVector, a proximity vector; State, a state matrix; and Degrees, a degrees list, are created. The ordered triples that are constructed from the distances between the pairs of distinct data points and the indices of the respective data points are stored in proxVector. State holds the linkage information or state that is embedded in the ordered triples as of the threshold distances d′, and Degrees holds the degrees of the data points. State is initialized as an identity matrix because initially, each data point in Xis assigned to its own cluster.

FIG. 7, Pseudocode 1 Lines 3-5. The distance d_{i,j}, i,j=1, 2, . . . ,n, i≠j, between each pair of distinct data points xᵢ and xⱼ in X is calculated, ordered triples (d_{i,j}, i,j) are constructed from these distances and the indices of the respective data points, and the ordered triples are stored in proxVector. It is unnecessary to construct ordered triples for each data point and itself because the state matrix is initialized as an identity matrix. One or more preferred embodiments work with metric or nonmetric dissimilarity measures.

FIG. 7, Pseudocode 1 Line 6. The ordered triples are sorted according to their distance elements. Ties between the distance elements are resolved by comparing the indices of the data points stored in the ordered triples. Merge sort is used to sort the ordered triples because it is parallelizable. When the number of data points is small or the ordered triples are nearly in rank order, insertion sort may perform better. Depending on the size of the data set and whether meaningful levels of a hierarchical sequence are known in advance, sorting can be omitted.

Sorting the ordered triples makes it convenient to visually determine whether increasing the dimensionality of the data points will reduce the effects of noise on the cluster set construction process. To do so, the magnitudes or lengths of the vectors that store the dissimilarities between pairs of data points are calculated using a p-norm, p ∈[1,∞). The ordered triples are used to construct a distance graph, wherein rank order indices are independent variable values and distance elements are dependent variable values of the graph. If there is inherent structure in the data set, the dimensionality of the data points may be increased until the inherent structure is sufficiently well-defined or defined as well as can be for the intended use, i.e., where the lower-right corners in the graph are sufficiently well-defined or defined as well as can be. The rank order indices of the ordered triples, by virtue of their distance elements, coincide with the levels of the corresponding hierarchical sequence. As illustrated in FIG. 5, along the axes of the distance graph, locate the rank order indices and/or the distance elements that correspond to where the lower-right corners appear in the graph. Under ideal circumstances, i.e., where the corners are nearly orthogonal, these indices and distance elements correspond, respectively, to meaningful levels and threshold distances d′ of the hierarchical sequence and can be used to set Guard for select levels of the hierarchical sequence at which to construct cluster sets.

FIG. 7, Pseudocode 1 Lines 7-15,18, and 19. Assuming that they have been sorted into rank order, the ordered triples are evaluated in ascending order according to their distance elements, and the linkage information that is embedded in the ordered triples is recorded in State. Other than shifting the threshold distances d′ at which cluster sets are constructed, monotonic transformations of the distances d_{i,j} have no effect on cluster set construction, since the rank order of the ordered triples is preserved.

The following numerals are used as symbols or indicators to represent basic linkage information in State:

A “2” indicates that 1) a data point is linked to another data point or a pair of data points are linked and 2) the data point or pair of data points have not been included in a previously constructed cluster (with respect to a particular cluster set).

A “1” indicates that a data point is not linked to another data point, i.e., it is a singleton.

A “0” indicates that a pair of data points are not linked. A “−2” indicates that 1) a data point is linked to another data point or a pair of data points are linked and 2) the data point or pair of data points have been included in a previously constructed cluster (with respect to a particular cluster set).

State is initialized as an identity matrix so entries State[i,i]=1, i=1, 2, . . . , n, n, convey that each data point in X is a singleton, and entries State[i,j]=0, i,j=1, 2, . . . , n, i≠j, convey that data points xi and z are not linked. To begin evaluating the ordered triples for linkage information, the data points described in the first ordered triple are evaluated separately, according to one of two rules. If data point xᵢ is a singleton (the degree of xᵢ equals 0 at the time of the evaluation), the entry at State[i,i] changes from “1” to “2”, and the entry at State[j,i] changes from “0” to “2”. If data point x, is not a singleton (the degree of z is greater than 0 at the time of the evaluation), the entry at State[i,i] changes from “0” to “2”. Analogous rules apply when data point x₃, is evaluated. Alternative sets of rules may work as well, as long as the end result provides the same linkage information in State. State is symmetric, so all the linkage information is contained in both the upper and the lower triangles of the matrix. The upper and lower parts are completed to make cluster construction easier. As linkage information is recorded in State, the degrees of data points z and z are incremented in Degrees. Each ordered triple is evaluated in turn until all the ordered triples are evaluated or stoppingCriteria is satisfied.

By evaluating the ordered triples in ascending order, in essence, threshold distance d′ is being increased from 0 to the maximum of all the distance elements. Although threshold distance d′ can vary continuously from 0 (where each data point is a singleton) to at least this maximum distance (where all the data points belong to the same cluster), practically, the only values that matter are the (n·(n−1))/2 values equal to the distances d_{i,j}. Since the number of data points in X is finite, the maximum number of levels of a fully constructed hierarchical sequence is finite and equal to the number of ordered triples (or the set of their distance elements) plus one.

FIG. 7, Pseudocode 1 Lines 16 and 17. After each ordered triple is evaluated, the conditional Guard is evaluated to determine whether a cluster set will be constructed. If Guard returns true, the state matrix, the degrees list, and n are passed to the cluster set construction process CONSTRUCTCLUSTERS. The state matrix is passed by value.

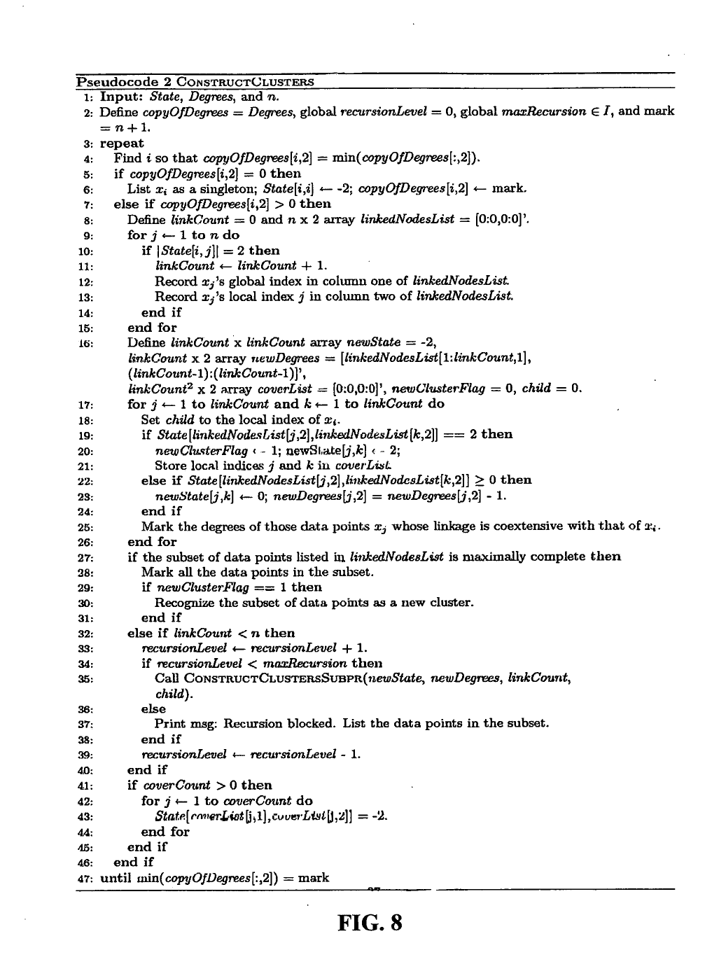

FIG. 8, Pseudocode 2 Line 2. To begin the cluster set construction process, copyOfDegrees and variables recursionLevel and maxRecursion are created. copyOfDegrees is used to find unmarked data points having the smallest degree and to track which data points have been marked, so that they cannot be (re-)selected as an unmarked data point having the smallest degree. Degrees remains unchanged because it is used inside a conditional, as described below. recursionLevel and maxRecursion are global variables, to avoid passing them as parameters in recursive calls. recursionLevel tracks the depth at which a subproblem will be solved if a recursive call is allowed, and maxRecursion limits the depth to which recursive calls are allowed.

FIG. 8, Pseudocode 2 Line 4. To begin the outer loop, CONSTRUCTCLUSTERS finds unmarked data point xᵢ having the smallest degree in copyOfDegrees. Ties are resolved by selecting the data point having the smallest index.

FIG. 8, Pseudocode 2 Lines 5 and 6. If the degree of data point xᵢ is zero, the data point is a singleton and marked. To mark data point xᵢ, copyOfDegrees[i,2] is increased to n+1, i.e., xᵢ's degree is raised to a number that is greater than the largest possible degree of any data point. State[i,i] changes from “1” to “−2”, to indicate that data point x, has been included in a cluster.

FIG. 8, Pseudocode 2 Lines 7-15 and 46. If the degree of data point xᵢ is greater than zero, an instance of linkCount and linkedNodesList, a linked nodes list, are created. linkCount holds the number of data points to which data point xᵢ is linked (including xᵢ). linkedNodesList holds the global (data array) and local indices of each such data point. The global indices are obtained from the first column of Degrees or copyOfDegrees. The local indices correspond to the indices of the rows in which these data points appear in State, Degrees, or copyOfDegrees. To find the data points to which data point xᵢ is linked, CONSTRUCTCLUSTERS scans the ith row of State for linkage, i.e., whether |State[i,j]|=2, j=1, 2, . . . , n. Where linkage is indicated, linkCount is incremented, and the global and local indices of the corresponding data point xⱼ are stored in linkedNodesList.

FIG. 8, Pseudocode 2 Lines 16-24 and 26. For each data point in the above-described subset of data points, two tasks are concurrently performed. First, CONSTRUCTCLUSTERS determines whether each data point is linked to each of the other data points, i.e., whether the subset of data points is maximally complete. Second, as the linkage is checked, CONSTRUCTCLUSTERS sets up a clustering subproblem for the subset of data points. If the subset is not maximally complete, recursion may be employed to solve the subproblem.

To set up a clustering subproblem, an instance of newState, a newState matrix; newDegrees, a newDegrees matrix; coverList, a cover list; and newClusterFlag are created. The row and column dimensions of newState and the row dimension of newDegrees equal linkCount. The entries in the first column of newDegrees are set to the entries in the first column of linkedNodesList (the global indices), and, as a design choice, the entries in the second column are set to linkCount −1, the maximum possible degree that any data point in the subproblem can have. Likewise, all the entries in newState are set to “−2”. In one or more embodiments, an instance of child may also be created. child is used to track the unmarked data point having the smallest degree from which a clustering subproblem originates.

If the entries in State indicate that the subset includes at least two data points xⱼ and xₖ, j, k=1, 2, . . . , linkCount, that are linked but have not been included in the same previously constructed cluster, i.e., State[j,k]=2, newClusterFlag is set to 1, the corresponding entries in newState are set to “2”, and the indices of the data points are stored in coverList. If the entries in State indicate that data points xⱼ and xₖ are not linked, the corresponding entries in newState are set to “0”, and their respective degrees in newDegrees are decremented.

FIG. 8, Pseudocode 2 Line 25. The degrees of those data points in the subset whose linkage is coextensive with that of data point x, (including xᵢ) are marked in copyOfDegrees. To be coextensive, the degree of a data point, as listed in Degrees, must be equal to that of data point xᵢ, and the data point must be linked to the same data points as xᵢ. In other words, they must be linked to the same and no other data points.

FIG. 8, Pseudocode 2 Lines 27-31. If the subset of data points is maximally complete, all the data points in the subset are marked. By marking the data points in this manner, the data points migrate. If, in addition, newClusterFlag has been set to “1”, the subset of data points is recognized as a new cluster. For embodiments that include clusterTree, the cluster is added to this data structure.

FIG. 8, Pseudocode 2 Lines 32-40. If the subset of data points is not maximally complete and linkCount is less than n, the subset of data points comprises two or more overlapping, maximally complete clusters, and the subset is treated as a clustering subproblem. linkCount must be less than n to avoid redefining a clustering problem as a subproblem. If the depth of a recursive call exceeds the maximum depth allowable, further recursion is blocked. Otherwise CONSTRUCTCLUSTERSSUBPR is called. newState, newDegrees, and linkCount, are passed as parameters to CONSTRUCTCLUSTERSSUBPR. In embodiments that include child, child is also passed and becomes parent in CONSTRUCTCLUSTERSSUBPR, where it is used to avoid redundant cluster construction. newState becomes State and newDegrees becomes Degrees.

FIG. 8, Pseudocode 2 Lines 41-45. The linkage information in State is amended to include information about any newly constructed clusters. The indices stored in coverList are used to change the corresponding entries in State from “2” to “−2” to indicate that these data points or pairs of data points have been included in a previously constructed cluster. Using coverList is a shortcut for a more complex mechanism that is used in CONSTRUCTCLUSTERSSUBPR. Marking the data points is sufficient to preclude redundant cluster construction where at least one data point in each cluster is well-separated. Additional means are needed when recursion is employed.

FIG. 8, Pseudocode 2 Lines 3 and 47. Once State is amended, CONSTRUCTCLUSTERSfinds the next unmarked data point having the smallest degree in copyOfDegrees. The cluster construction process reiterates until all the data points are marked.

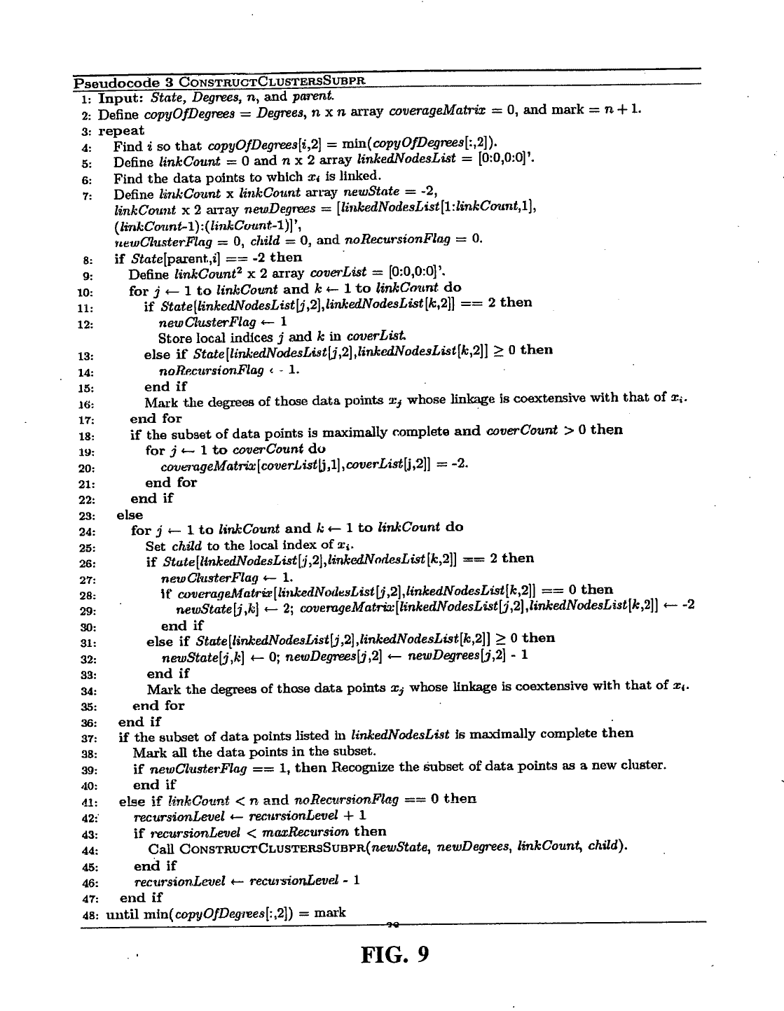

FIG. 9, Pseudocode 3 is similar to FIG. 8, Pseudocode 2. Two notable differences distinguish the two components. First, Pseudocode 2 is responsible for identifying singleton data points, marking these data points, and amending State accordingly. Second, Pseudocode 2 and Pseudocode 3 use different albeit related means for tracking information about previously constructed clusters, in order to avoid redundant cluster construction.

To track information about previously constructed clusters when an embodiment includes child, two data structures, coverageMatrix, a coverage matrix, and coverList, a cover list, are used. Three variables, child, parent, and noRecursionFlag are also used. child is passed to CONSTRUCTCLUSTERSSUBPR to track the unmarked data point having the smallest degree from which the recursive call originated, child becomes parent inside the call to CONSTRUCTCLUSTERSSUBPR, and noRecursionFlag is used to block a recursive call if State[parent,i]=−2, where i is the index of the unmarked data point xᵢ having the smallest degree. This conditional is used to reduce the number of permutations that are evaluated in order to construct a cluster set.

FIG. 9, Pseudocode 3 Lines 1, 2, and 4-11. An instance of coverageMatrix is created, copyOfDegrees is used to find the unmarked data point xᵢ having the smallest degree, and the data points to which data point xᵢ is linked are identified.

FIG. 9, Pseudocode 3 Lines 12-26. If State[parent,i]=−2, the subset of data points is examined for maximal completeness and whether the subset includes at least one pair of data points that has not been included in a previously constructed cluster. If a pair of data points has not been included in a previously constructed cluster, the indices of the respective data points are recorded in coverList. If the subset is maximally complete, the subset of data points is recognized as a new cluster, and the indices stored in coverList are used to amend coverageMatrix. If the subset is not maximally complete, recursion will not be allowed, regardless of whether the maximum recursion level has been reached, but all the data points whose linkage is coextensive with that of data point xᵢ are marked.

FIG. 9, Pseudocode 3 Lines 25-36. If State[parent,i]=2, the same steps as in Pseudocode 2 are followed, except coverageMatrix is amended instead of storing indices in coverList and using coverList to amend State.

In summary, coverageMatrix is used to track information about previously constructed clusters and to amend newState before it is passed as a parameter in a recursive call. When recursion is allowed, coverageMatrix is amended as part of setting up a clustering subproblem. When recursion is not allowed, coverageMatrix is not amended until it is known whether a subset of data points is maximally complete and recognized as a new cluster. Until it is known whether or not coverageMatrix should be amended, coverList is used in the interim. In CONSTRUCTCLUSTERS, coverList is used in place of coverageMatrix as an expedient, where it is used to amend State just before each subsequent unmarked data point having the smallest degree is determined.

Three means are used to avoid redundant cluster construction. First, data points are marked so that they cannot be (re-)selected as an unmarked data point having the smallest degree. Second, child and parent are used to limit the number of permutations that are evaluated. Third, coverageMatrix is used to track information about previously constructed clusters. Where coverageMatrix cannot be amended directly or where it is expedient to do so, coverList is used in the interim or in its place.

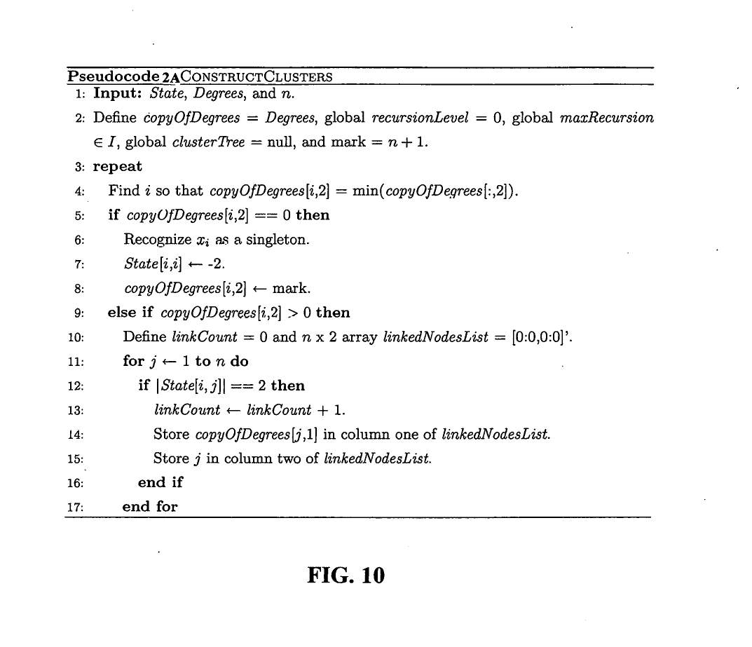

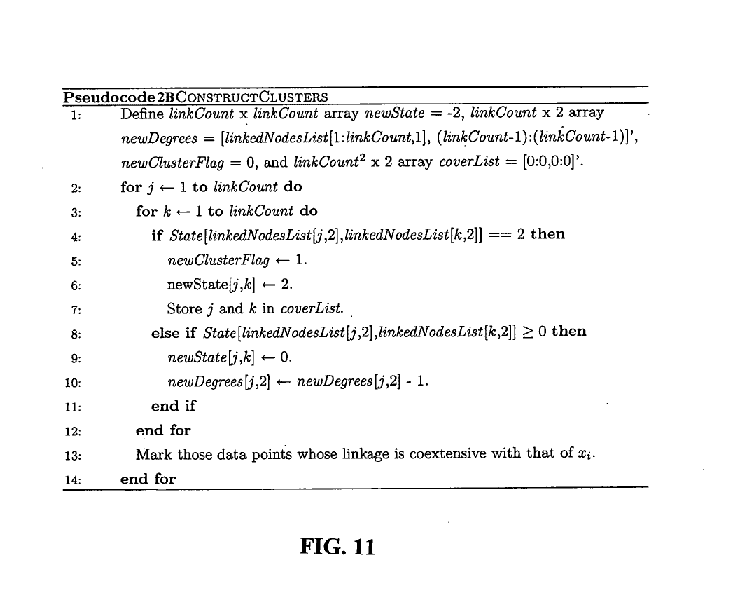

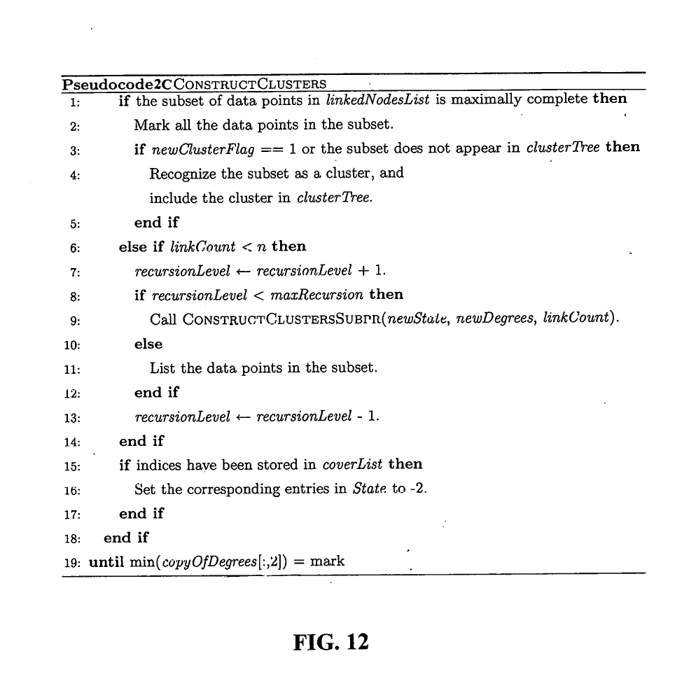

FIGS. 10-12, Pseudocode 2A, 2B, and 2C. In embodiments that use clusterTree, CONSTRUCTCLUSTERSSUBPR uses two data structures, coverageMatrix and clusterTree, to track information about previously constructed clusters. CONSTRUCTCLUSTERSSUBPR follows the same steps as CONSTRUCTCLUSTERS, except coverageMatrix is updated instead of storing indices in coverList and subsequently updating State. coveageMatrix is used to construct newState before it is passed to CONSTRUCTCLUSTERSSUBPR. If a subset of data points is maximally complete and recognized as a new cluster, the subset is added to clusterTree. If a subset of data points is maximally complete but the entries in State for every data point and every pair of data points are “−2”, clusterTree is checked to determine whether the subset comprises a previously constructed cluster. Having all “−2” entries is a necessary but not a sufficient condition for identifying redundant cluster construction. If the subset is already included in clusterTree, the subset is ignored. If the subset is not already included in clusterTree, it is recognized as a cluster and added to clusterTree.

In summary, three means are used to avoid redundant cluster construction. First, data points are marked so that they cannot be (re)-selected as a data point having the smallest degree. Second, coverList and coverageMatrix are used to track information about previously constructed clusters. Third, clusterTree is used to represent subsets of data points that have been recognized as clusters. When, with respect to State, all the entries for a subset of data points are “−2”, clusterTree is used to check whether the subset should be recognized as a cluster or not.

One or more embodiments of the present invention are implemented as computer programs for sequential processing, parallelized processing, or combinations thereof. They may be implemented for use with the processor of a general purpose computer, a specialized processor or computer, a programmable controller, or hardware such as field programmable gate arrays or application specific integrated circuits. The embodiments that have been described herein are non-limiting examples, as embodiments of the present invention are extensible in numerous ways, and changes, modifications, variations, and alternatives can be made to these embodiments that are still within the spirit of the present invention. This text takes precedence over the text in the provisional applications wherever they are irreconcilable, and the computer program takes precedence over any text that is irreconcilable with the program.

1. A computer program encoded in a computational device and used for constructing one or more cluster sets of one or more hierarchical sequences having one or more levels, comprising:
a. means for loading data into the computational device, wherein the data represent two or more data points, and wherein one or more indices are associated with each data point;
b. means for calculating one or more sets of distances for the data points, wherein each set of distances includes one or more distances for each pair of data points, and indices of the respective data points are associated with the distances;
c. means for finding one or more meaningful levels of a hierarchical sequence that is constructible from a set of distances and the data points associated with these distances, wherein whether a level of the hierarchical sequence is meaningful is determinable prior to the beginning of when the corresponding cluster set is constructible;
d. means for evaluating a set of distances and the associated data points for linkage information; and
e. means for using the linkage information to construct a cluster set only for each select level of the hierarchical sequence, wherein any level of the hierarchical sequence is selectable.

2. The computer program in claim 1, wherein one or more p-norms, p ∈[1,∞), are used to calculate the distances.

3. The computer program in claim 1, wherein the means for finding meaningful levels is one or more images that are visually examined for one or more features that correlate with meaningful levels of a hierarchical sequence.

4. The computer program in claim 3, wherein the one or more images are one or more distance graphs.

5. The computer program in claim 1, including a means for associating one or more rank order indices with each distance in a set of distances, and wherein the means for finding meaningful levels uses one or more differences between distances from the set of distances and one or more differences between rank order indices associated with these distances.

6. The computer program in claim 1, wherein the means for finding meaningful levels includes optionally increasing the dimensionality of the data points.

7. The computer program in claim 1, wherein the means for evaluating a set of distances and the associated data points for linkage information includes tracking one or more degrees of the data points, and wherein the means for constructing cluster sets uses these degrees in ascending order to identify subsets of data points from which one or more clusters are constructible.

8. The computer program in claim 7, wherein a system for marking data points determines which data points qualify for being selected as a data point having the smallest degree, and wherein at least one unmarked data point having the smallest degree is selected to identify at least one subset of data points from which at least one cluster is constructible.

9. The computer program in claim 8, wherein when a data point that is selected to identify at least one subset of data points from which one or more subsets of clusters is constructible and that data point belongs to more than one maximally complete subset of data points, recursion is used to find the subsets of clusters.

10. The computer program in claim 1, further comprising a means for determining whether a maximally complete subset of data points is recognizable as a cluster, wherein the means includes an adaptation of a binary search tree.

11. A computer program encoded in a computational device and used for constructing one or more cluster sets of one or more hierarchical sequences having one or more levels, comprising:
a. means for loading data into the computational device, wherein the data represent two or more data points, and wherein one or more indices are associated with each data point;
b. means for calculating one or more sets of distances for the data points, wherein each set of distances includes one or more distances for each pair of data points, and indices of the respective data points are associated with the distances;
c. means for finding one or more meaningful levels of a hierarchical sequence that is constructible from a set of distances and the data points associated with these distances, wherein one or more rank order indices are associated with each distance, wherein whether a level of the hierarchical sequence is meaningful is determinable prior to the beginning of when the corresponding cluster set is constructible, and wherein one or more differences between distances from the set of distances and one or more differences between rank order indices associated with these distances are used to find meaningful levels;
d. means for evaluating a set of distances and the associated data points for linkage information; and
e. means for using the linkage information to construct a cluster set only for each select level of the hierarchical sequence, wherein any level of the hierarachical sequence is selectable.

12. The computer program in claim 11, further comprising a means for determining whether a maximally complete subset of data points is recognizable as a cluster, wherein the means includes an adaptation of a binary search tree.

13. A computer program encoded in a computational device and used for constructing one or more cluster sets of one or more hierarchical sequences having one or more levels, comprising:
a. means for loading data into the computational device, wherein the data represent two or more data points, and wherein one or more indices are associated with each data point;
b. means for calculating one or more sets of distances for the data points, wherein each set of distances includes one or more distances for each pair of data points, and indices of the respective data points are associated with the distances;
c. means for evaluating a set of distances and the associated data points for linkage information; and
d. means for using the linkage information to construct a cluster set only for each select level of the hierarchical sequence, wherein any level of the hierarchical sequence is selectable.

14. The computer program in claim 13, further comprising a means for determining whether a maximally complete subset of data points is recognizable as a cluster, wherein the means includes an adaptation of a binary search tree.

15. A method implemented in a computational device and used for constructing one or more cluster sets of one or more hierarchical sequences having one or more levels, comprising:
a. loading data into the computational device, wherein the data represent two or more data points, and wherein one or more indices are associated with each data point;
b. calculating one or more sets of distances for the data points, wherein each set of distances includes one or more distances for each pair of data points, and indices of the respective data points are associated with the distances;
c. finding one or more meaningful levels of a hierarchical sequence that is constructible from a set of distances and the data points associated with these distances, wherein whether a level of the hierarchical sequence is meaningful is determinable prior to the beginning of when the corresponding cluster set is constructible;
d. evaluating a set of distances and the associated data points for linkage information; and
e. using the linkage information to construct a cluster set only for each select level of the hierarchical sequence, wherein any level of the hierarchical sequence is selectable.

16. The method in claim 15, wherein the finding meaningful levels step uses one or more images that are visually examined for one or more features that correlate with meaningful levels of a hierarchical sequence.

17. The method in claim 16, wherein the one or more images are one or more distance graphs.

18. The method in claim 15, including associating one or more rank order indices with each distance in a set of distances, and wherein the finding meaningful levels step uses one or more differences between distances from the set of distances and one or more differences between rank order indices associated with these distances.

19. The method in claim 15, wherein the finding meaningful levels step includes optionally increasing the dimensionality of the data points.

20. The method in claim 15, wherein when a data point that is selected to identify at least one subset of data points from which one or more subsets of clusters is constructible and that data point belongs to more than one maximally complete subset of data points, recursion is used to find the subsets of clusters.

21. The computer program in claim 15, further comprising a means for determining whether a maximally complete subset of data points is recognizable as a cluster, wherein the means includes an adaptation of a binary search tree.
